(19) United States
(12) Patent Application Publication
(10) Pub. No.: US 2025/0367549 A1
(43) Pub. Date: Dec. 4, 2025

(54) CLOUD GAME SELECTION METHOD AND APPARATUS, DEVICE, MEDIUM, AND PROGRAM PRODUCT

(71) Applicant: Tencent Technology (Shenzhen) Company Limited, Shenzhen (CN)

(72) Inventors: Pengfei YUAN, Shenzhen (CN); Jinmei DENG, Shenzhen (CN); Jinmei DENG, Shenzhen (CN)

(21) Appl. No.: 19/296,765

(22) Filed: Aug. 11, 2025

Related U.S. Application Data
(63) Continuation of application No. PCT/CN2024/096951, filed on Jun. 3, 2024.

(51) Int. Cl. A63F 13/355; A63F 13/533

(52) U.S. Cl. CPC A63F 13/355; A63F 13/533

(57) ABSTRACT

A cloud game selection method is performed by a computer device. The method includes: displaying a plurality of cloud games mounted on a cloud game platform, the cloud games being associated with a first account of a user of the computer device; receiving a first selection operation on a first cloud game among the plurality of cloud games by the user of the computer device; in response to the first selection operation: adding the first account to a first service queue corresponding to the first cloud game, and the first service queue representing an account queuing status of the first cloud game; and displaying an object arrangement state including the first cloud game selected by the first account, and the object arrangement state being configured for presenting a queuing status of the first account.

### CROSS-REFERENCE TO RELATED APPLICATIONS

This application is a continuation application of PCT Patent Application No. PCT/CN2024/096951, entitled “CLOUD GAME SELECTION METHOD AND APPARATUS, DEVICE, MEDIUM, AND PROGRAM PRODUCT” filed on Jun. 3, 2024, which claims priority to Chinese Patent Application No. 202310965051.7, entitled “CLOUD GAME SELECTION METHOD AND APPARATUS, DEVICE, MEDIUM, AND PROGRAM PRODUCT” filed on Aug. 1, 2023, both of which are incorporated by reference in their entirety.

### FIELD OF THE TECHNOLOGY

Embodiments of this application relate to the field of human-computer interaction, and in particular, to a cloud game selection method and apparatus, a device, a medium, and a program product.

### BACKGROUND OF THE DISCLOSURE

With the improvement of cultural and entertainment living standards, people have increasingly higher life experience and requirements on virtual scenes. As a representation manner of the virtual scenes, games have become a channel for many people to release pressure. A cloud game is an online game manner based on cloud computing. Because storage, computation, image rendering, and the like of a game are completely performed on a cloud server, the game has a wider range of application scenes without a constraint on hardware performance, and attracts increasing attention.

In the related art, when a player selects a cloud game by means of a cloud game platform for a game process, the player selects a cloud game from a plurality of cloud games provided in the cloud game platform. Based on a user bearing limitation of a server in the cloud game, the player may need to queue up in the currently selected cloud game. Only when the queue reaches the player, may the player enter the cloud game to start the game process.

However, in the foregoing process, the selection of the player for the cloud game is single, and the game process of the player is strongly dependent on a queuing status of the selected single cloud game. Consequently, a probability that the player effectively participates in the game is relatively low, the player cannot participate in the game efficiently, and human-computer interaction efficiency is relatively low.

### SUMMARY

Embodiments of this application provide a cloud game selection method and apparatus, a device, a medium, and a program product, which can avoid a problem that a first account can queue up only in a single cloud game, and consequently, a probability of participating in a game is relatively low. A queuing status of the first account queuing up in a plurality of cloud games is viewed in time and accurately by using an object arrangement state, thereby enabling a player to participate in a cloud game more efficiently, and improving human-computer interaction efficiency. The following technical solutions are adopted.

According to an aspect, a cloud game selection method is performed by a computer device. The method includes:
displaying a plurality of cloud games mounted on a cloud game platform, the cloud games being associated with a first account of a user of the computer device;
receiving a first selection operation on a first cloud game among the plurality of cloud games by the user of the computer device;
in response to the first selection operation, adding the first account to a first service queue corresponding to the first cloud game, and the first service queue representing an account queuing status of the first cloud game; and
displaying an object arrangement state including the first cloud game selected by the first account, and the object arrangement state being configured for presenting a queuing status of the first account.

According to another aspect, a computer device is provided. The computer device includes a processor and a memory. The memory has at least one instruction, at least one program, a code set, or an instruction set stored therein. The at least one instruction, the at least one program, the code set, or the instruction set is loaded and executed by the processor and causes the computer device to implement the cloud game selection method according to any one of the foregoing embodiments of this application.

According to another aspect, a non-transitory computer-readable storage medium is provided. The storage medium has at least one instruction, at least one program, a code set, or an instruction set stored therein. The at least one instruction, the at least one program, the code set, or the instruction set is loaded and executed by a processor of a computer device and causes the computer device to implement the cloud game selection method according to any one of the foregoing embodiments of this application.

The technical solutions provided in the embodiments of this application produce at least the following beneficial effects.

A plurality of cloud games are provided for a user. The user may select a first cloud game from the plurality of cloud games in a cloud game platform. An account of the user is added to a first service queue corresponding to the first cloud game. A computer device displays an object arrangement state according to a selection status of the user on the cloud game, to present, according to the object arrangement state, a queuing status of the account of the user in at least one cloud game selected by the user. To be specific, a first account is added, by means of a first selection operation on the first cloud game from the plurality of cloud games, to the first service queue corresponding to the selected first cloud game, so that the first account can perform a queuing process in the first cloud game. In addition, a queuing status in at least one cloud game queuing up simultaneously may be viewed according to the object arrangement state, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using the object arrangement state, thereby greatly improving a probability of participating in a game by the first account in time, enabling a player to participate in a cloud game more efficiently, and improving human-computer interaction efficiency.

### BRIEF DESCRIPTION OF THE DRAWINGS

FIG. 1 is a schematic diagram of an implementation environment according to an exemplary embodiment of this application.

FIG. 2 is a flowchart of a cloud game selection method according to an exemplary embodiment of this application.

FIG. 3 is a flowchart of a cloud game selection method according to another exemplary embodiment of this application.

FIG. 4 is a schematic interface diagram of an object exhibition interface according to an exemplary embodiment of this application.

FIG. 5 is a schematic interface diagram of performing a first selection operation on a first cloud game in an object exhibition interface according to an exemplary embodiment of this application.

FIG. 6 is a schematic interface diagram of displaying an object arrangement window through a first selection operation according to an exemplary embodiment of this application.

FIG. 7 is a schematic interface diagram of an object arrangement window according to an exemplary embodiment of this application.

FIG. 8 is a schematic interface diagram of an object arrangement window according to another exemplary embodiment of this application.

FIG. 9 is a schematic interface diagram of displaying an object arrangement order in an expanded manner according to an exemplary embodiment of this application.

FIG. 10 is a flowchart of a method for displaying a prompt window after an object arrangement state according to an exemplary embodiment of this application.

FIG. 11 is a schematic interface diagram of a first prompt window according to an exemplary embodiment of this application.

FIG. 12 is a schematic interface diagram of a second prompt window according to an exemplary embodiment of this application.

FIG. 13 is a schematic interface diagram of an object arrangement window according to still another exemplary embodiment of this application.

FIG. 14 is a flowchart of a cloud game selection method according to still another exemplary embodiment of this application.

FIG. 15 is a structural block diagram of a cloud game selection apparatus according to an exemplary embodiment of this application.

FIG. 16 is a structural block diagram of a cloud game selection apparatus according to another exemplary embodiment of this application.

FIG. 17 is a structural block diagram of a terminal according to an exemplary embodiment of this application.

### DESCRIPTION OF EMBODIMENTS

First, terms described in embodiments of this application are briefly introduced.

A cloud technology is a collective name of a network technology, an information technology, an integration technology, a platform management technology, an application technology, and the like based on an application of a cloud computing business mode, and may form a resource pool, which is used as required, and is flexible and convenient. The cloud computing technology is to become an important support. Back-end services of a technology network system require a huge amount of computing and storage resources, such as video websites, image websites, and more portal websites. With the development and application of the Internet industry, each item may have an identification flag and needs to be transmitted to the background system for logic processing. Data of different levels is processed separately. Various industry data needs powerful system support, and this can be implemented only through cloud computing.

The cloud computing is a mode of delivery and use of an Internet technology (IT) infrastructure, and is obtaining required resources in an on-demand and easily scalable manner through a network. Generalized cloud computing is a mode of delivery and usage of services, and is obtaining required services in an on-demand and easily scalable manner through the network. Such services may be related to IT, software, and the Internet, or may be other services. The cloud computing is a product of fusion and development of conventional computers and network technologies such as grid computing, distributed computing, parallel computing, utility computing, network storage technologies, virtualization, and load balance.

In embodiments of this application, a first account is added, by means of a first selection operation on a first cloud game among a plurality of cloud games, to a first service queue corresponding to the selected first cloud game, so that the first account can perform a queuing process in the first cloud game. In addition, a queuing status in at least one cloud game queuing up simultaneously may be viewed according to an object arrangement state, thereby avoiding a problem that the first account can queue up only in a single cloud game, and consequently, a probability of participating in a game is relatively low. A queuing status of the first account in the plurality of selected cloud games is viewed in time and accurately by using the object arrangement state, thereby greatly improving a probability of participating in a game by the first account in time, enabling a player to participate in a cloud game more efficiently, and improving human-computer interaction efficiency.

In this application, before related data of a user is collected and in the process of collecting the related data of the user, a prompt interface, a pop-up window, or voice prompt information may be displayed. The prompt interface, the pop-up window, or the voice prompt information is configured for prompting that the user is currently collecting the related data of the user, so that in this application, only after a confirmation operation transmitted by the user to the prompt interface or the pop-up window is obtained, the related operation of obtaining the related data of the user starts to be performed. Otherwise, (namely, when the confirmation operation transmitted by the user to the prompt interface or the pop-up window is not obtained), the related operation of obtaining the related data of the user ends. To be specific, the related data of the user is not obtained. In other words, all user data gathered in this application is gathered when the user agrees and authorizes, and the related user data needs to be collected, used, and processed by complying with related laws and regulations and standards of related regions.

In addition, an implementation environment involved in the embodiments of this application is described. A cloud game selection method provided in an embodiment of this application may be independently performed by a terminal, or may be performed by a server, or may be implemented by the terminal and the server through data interaction. This is not limited in this embodiment of this application. In some embodiments, an example in which the terminal and the server interact to perform the cloud game selection method is used for description.

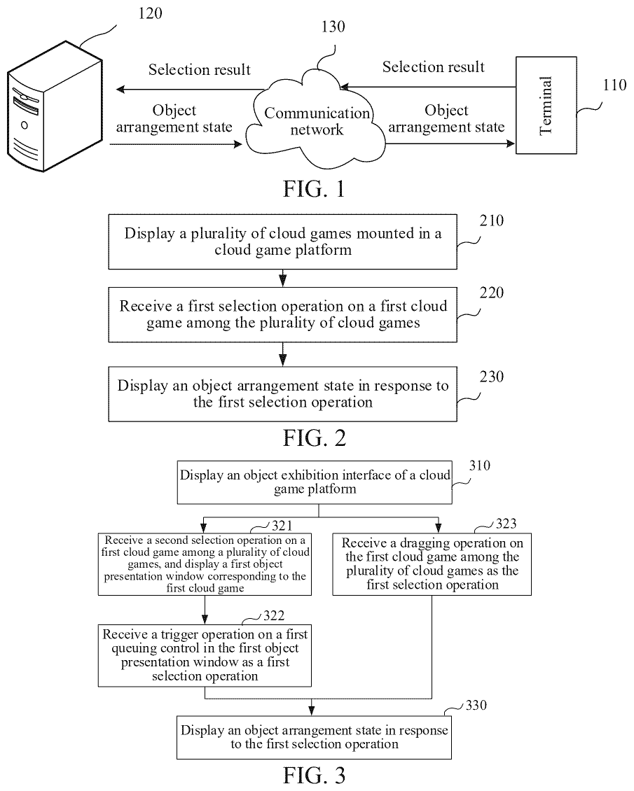

Schematically, referring to FIG. 1, the implementation environment relates to a terminal 110 and a server 120. The terminal 110 is connected to the server 120 by using a communication network 130.

In some embodiments, a cloud game application provided by a cloud game platform is installed in the terminal 110. The cloud game application is configured for providing a cloud game entrance for a player, so that the player can start a game process by triggering a cloud game mounted in the cloud platform. The cloud game application may be conventional application software, may be cloud application software, may be implemented as an applet or an application module in a host application, or may be a web platform. This is not limited herein.

In some embodiments, an object exhibition interface of a cloud game platform is displayed on the terminal 110. A first account is logged into the cloud game platform. The object exhibition interface is configured for displaying a plurality of cloud games mounted on the cloud game platform. The cloud games are configured for providing a game service to the first account. Schematically, the terminal 110 displays an object exhibition interface based on an operation of opening a cloud game application, and presents a plurality of cloud games.

In some embodiments, the terminal 110 receives a first selection operation on a first cloud game among the plurality of cloud games. The first selection operation is configured for adding the first account to a first service queue corresponding to the first cloud game, and the first service queue is configured for representing an account queuing status of the first cloud game when providing the game service.

Schematically, after receiving a first selection operation on a first cloud game, the terminal 110 notifies the server 120 of a selection result of a first account for the first cloud game by using the communications network 130. The server 120 adds, based on the selection process, the first account to a first service queue corresponding to the first cloud game. In addition, the server 120 may learn, through the first service queue corresponding to the first cloud game, an account queuing status of the first cloud game when providing a game service. The first service queue can also present a queuing status of the first account therein. Similarly, the server 120 may learn, by using a service queue corresponding to another cloud game, an account queuing status of the another cloud game when providing a game service.

In some embodiments, the terminal 110 displays an object arrangement state in response to the first selection operation. The object arrangement state includes at least one cloud game selected by the first account. The at least one cloud game includes the first cloud game. Schematically, after the terminal 110 receives a first selection operation on at least one cloud game, the at least one cloud game includes a currently selected first cloud game, the terminal 110 notifies the server 120 of a selection result of the first cloud game by using the communications network 130. The server 120 can query a queuing status of the first account in the at least one cloud game, to feed back an object arrangement state to the terminal 110 by using the communications network 130, to present the queuing status of the first account in the at least one cloud game by using the object arrangement state, so that the first account learns a current queuing status of the first account by using the object arrangement state displayed by the terminal 110. For example, the first account is ranked 25^{th} in the first cloud game, and is ranked 16^{th} in another cloud game A.

The terminal includes, but is not limited to, mobile terminals such as a mobile phone, a tablet computer, a portable laptop computer, an intelligent voice interaction device, an intelligent home appliance, and an in-vehicle terminal, and may be implemented as a desktop computer or the like. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In some embodiments, the server may be further implemented as a node in a blockchain system.

The cloud game selection method provided in this application is described with reference to the foregoing introduction to nouns and application scenes. An example in which the method is performed by a computer device is used for description. As shown in FIG. 2, the method includes the following operations 210 to 230.
Operation 210: Display a plurality of cloud games mounted on a cloud game platform.

Schematically, the cloud game platform is a platform providing a plurality of cloud games. A player can conveniently view, select, and participate in the plurality of cloud games by using the cloud game platform.

In some embodiments, a cloud game application developed and run by using the cloud game platform provides various services provided by the cloud game platform for the player, for example, performing account login, selecting a cloud game to battle, collecting a cloud game, and making a comment. To be specific, the cloud game application can provide a cloud game entrance for the player, so that the player can start a game process by triggering a cloud game mounted in the cloud platform.

Schematically, the cloud game application may be conventional application (APP) software, may be cloud application software, may be implemented as an applet or an application module in a host application, or may be a web platform. This is not limited herein.

A first account is logged into the cloud game platform.

Schematically, the first account is an account logged into the cloud game application. Alternatively, the first account is a device account logged into a terminal on which the cloud game application is installed. Alternatively, the first account is an account logged into a host program configured with a cloud game applet, or the like.

In some embodiments, an object exhibition interface of the cloud game platform is displayed by opening the cloud game application provided by the cloud game platform. Alternatively, an object display operation is performed on the cloud game application, and an object exhibition interface of the cloud game platform is displayed. For example, a trigger operation performed on an object display control in the cloud game application is used as the object display operation, to display the object exhibition interface. Alternatively, voice trigger is used as the object display operation, to display the object exhibition interface (for example, a voice text is “Display a plurality of cloud games”).

In some embodiments, the cloud game application provides an object exhibition interface for a user. To be specific, an object exhibition interface of the cloud game platform is displayed. The object exhibition interface is configured for displaying a plurality of cloud games mounted on the cloud game platform. The cloud games are configured for providing a game service to the first account.

In some embodiments, the object exhibition interface is an interface displayed on a mobile phone terminal. Alternatively, the object presentation interface is an interface displayed on a television terminal. Alternatively, the object exhibition interface is an interface displayed by a computer terminal.

Schematically, the displayed object exhibition interface includes a plurality of cloud games, and the plurality of cloud games are cloud games mounted on the cloud game platform, thereby entering the cloud games through the cloud game platform to participate in the games. The object exhibition interface is an interface displayed by a terminal into which the first account is logged. Therefore, the first account may participate in a game by using a cloud game displayed in the object exhibition interface. To be specific, the cloud game provides a game service to the first account. The game service includes a plurality of services related to a running process of the cloud game, such as participating in a game battle, setting a game operation form, and matching teammates.
Operation 220: Receive a first selection operation on a first cloud game among the plurality of cloud games.

Schematically, the first cloud game is any one of the plurality of cloud games. After the object exhibition interface including the plurality of cloud games is displayed, the first selection operation on the first cloud game among the plurality of cloud games is received.

The first selection operation is configured for adding the first account to a first service queue corresponding to the first cloud game.

Schematically, the first selection operation corresponds to the first account. After the first selection operation is performed on the first cloud game, based on the first selection operation corresponding to the first account, a service queue corresponding to the first cloud game is determined as a first service queue, and the first account is added to the first service queue.

In some embodiments, after receiving the first selection operation, the terminal transmits a game identifier corresponding to the first cloud game and an account identifier corresponding to the first account to the server. The server determines, based on the game identifier, a first service queue corresponding to the first cloud game, and adds the first account to the first service queue based on the account identifier.

The first service queue is configured for representing an account queuing status of the first cloud game when providing the game service.

Schematically, the first cloud game corresponds to the first service queue, and the first service queue is a service queue determined after the first selection operation is performed on the first cloud game based on a plurality of accounts. In some embodiments, the first service queue includes a plurality of accounts. After the first account is added to the first service queue, the plurality of accounts include the first account, and there is a correspondence between a queuing order of the plurality of accounts in the first service queue and operation time of performing the first selection operation on the first cloud game by the plurality of accounts.

For example, account 1, account 2, and account 3 sequentially perform the first selection operation on the first cloud game on object selection interfaces respectively displayed on corresponding terminals. In this case, account 1, account 2, and account 3 are sequentially added to the first service queue corresponding to the first cloud game. The first service queue is presented as: account 1, account 2, and account 3.

In some embodiments, the first selection operation is implemented as a click/tap operation on the first cloud game. Alternatively, the first selection operation is implemented as a long-press operation on the first cloud game. Alternatively, the first selection operation is implemented as a dragging operation on the first cloud game. For example, dragging the first cloud game to a specified trigger region is considered as implementing the first selection operation on the first cloud game. Alternatively, the first selection operation is implemented as a voice trigger operation on a name of the first cloud game. For example, the name of the first cloud game is “Game A”, and based on a voice instruction “Open game A”, it is considered that the first selection operation on the first cloud game is implemented.

In an exemplary embodiment, when the computer device is implemented as a display device, a communication connection relationship is established between the display device and a control device. The connection relationship includes at least one of a wired connection relationship and a wireless connection relationship.

In some embodiments, a trigger operation performed by the control device on a first cloud game among the plurality of cloud games is received as the first selection operation. The display device is configured to provide a display function during cloud game selection, and a display content of the display device is adjusted based on the display device by using the control device connected to the display device.

In some embodiments, when the display device displaying the object exhibition interface is a mobile phone terminal, the first selection operation may be implemented in a form of a manual trigger operation, a voice trigger operation, or the like. When the display device displaying the object exhibition interface is a television terminal, the first selection operation may be implemented in a form of an external control device (such as an external handle, a keyboard (wired or wireless), or a mouse (wired or wireless)), a remote control, or a voice trigger operation. Alternatively, when the display device displaying the object exhibition interface is a computer terminal, the first selection operation may be implemented in a form of an external control device (for example, an external handle, a keyboard, or a mouse), a voice trigger operation, or a manual trigger operation.
Operation 230: Display an object arrangement state in response to the first selection operation.

The object arrangement state includes at least one cloud game selected by the first account. The at least one cloud game includes the first cloud game.

Schematically, the first account may select at least one cloud game by using an object selection interface. As any one of the plurality of cloud games, the first cloud game may be implemented as a 1^{st} cloud game selected by the first account, an nth cloud game (n is a positive integer greater than 1) selected for the first account, or the like.

The object arrangement state is configured for presenting a queuing status of the first account in at least one cloud game.

Schematically, by using the object arrangement state, the first account can learn at least one selected cloud game more intuitively, and can also learn a queuing status of the first account in the at least one cloud game.

In an exemplary embodiment, in response to the first selection operation, the at least one cloud game and an account queuing order respectively corresponding to the at least one cloud game are displayed as the object arrangement state.

The account queuing order is configured for representing a queuing status of the first account in a service queue corresponding to the cloud game.

Schematically, there is a one-to-one correspondence between the cloud game and the account queuing order. The object queuing order is implemented as a plurality of pairs of queuing orders that have a correspondence. For example, at least one cloud game selected by the first account includes cloud game A and cloud game B. An account queuing order corresponding to cloud game A is implemented as a 26^{th} position, representing that the first account is ranked 26^{th} in a service queue corresponding to cloud game A. Similarly, an account queuing order corresponding to cloud game B is implemented as a 58^{th} position, representing that the first account is ranked 58^{th} in a service queue corresponding to cloud game B.

When the displayed object arrangement state includes a cloud game and an account queuing order corresponding to the cloud game, a user may quickly learn positions of accounts in a current queue according to the object arrangement state, to improve transparency of a cloud game queuing process, thereby improving user experience. In addition, because the user may learn a current object queuing order in real time, when the object queuing order indicates that it is about to be the turn of the user, the user may prepare to start a game in advance, thereby avoiding application resource waste caused by an application waiting for a user response, and improving resource utilization efficiency of the application.

In some embodiments, the account queuing order includes a first account ranking result corresponding to the first cloud game. To be specific, after the first account performs the first selection operation on the first cloud game, a first account queuing order corresponding to the first cloud game is displayed in the account queuing order, to represent a queuing status of the first account in the first service queue corresponding to the first cloud game.

In some embodiments, the first account ranking result is displayed within a display region corresponding to the first cloud game in an object arrangement window.

The object arrangement window is configured for displaying the object arrangement state.

Schematically, the object arrangement state is displayed on the object arrangement window. For example, the object arrangement window is implemented as a window floating on the object exhibition interface. Alternatively, the object arrangement window is implemented as a window obtained by pulling up/down the object exhibition interface. Alternatively, the object arrangement window is implemented as a window jumped to and displayed on the object exhibition interface.

In some embodiments, the object arrangement window includes a plurality of display regions. Each display region corresponds to one cloud game. When the first account ranking result corresponding to the first cloud game is displayed, the first account ranking result is displayed within the display region corresponding to the first cloud game in the object arrangement window. For example, a game name of the first cloud game and the first account ranking result are displayed within the display region corresponding to the first cloud game in the object arrangement window. Alternatively, a game cover of the first cloud game, the first account ranking result, and the like are displayed.

The foregoing is merely an illustrative example. This is not limited in this embodiment of this application.

In conclusion, a plurality of cloud games are provided for a user. The user may select a first cloud game from the plurality of cloud games in a cloud game platform. An account of the user is added to a first service queue corresponding to the first cloud game. A computer device displays an object arrangement state according to a selection status of the user on the cloud game, to present, according to the object arrangement state, a queuing status of the account of the user in at least one cloud game selected by the user. To be specific, a first account is added, by means of a first selection operation on the first cloud game from the plurality of cloud games, to the first service queue corresponding to the selected first cloud game, so that the first account can perform a queuing process in the first cloud game. In addition, a queuing status in at least one cloud game queuing up simultaneously may be viewed according to the object arrangement state, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using the object arrangement state, thereby greatly improving a probability of participating in a game by the first account in time, enabling a player to participate in a cloud game more efficiently, and improving human-computer interaction efficiency.

In an exemplary embodiment, the first selection operation on the first cloud game may be implemented by using a dragging operation or a click/tap operation. Schematically, as shown in FIG. 3, the embodiment shown in FIG. 2 may alternatively be implemented as the following operations 310 to 330. The operation 220 shown in FIG. 2 may alternatively be implemented as the following operations 321 to 322 or operation 323.
Operation 310: Display an object exhibition interface of a cloud game platform.

A first account is logged into the cloud game platform. The object exhibition interface is configured for displaying a plurality of cloud games mounted on the cloud game platform. The cloud games are configured for providing a game service to the first account.

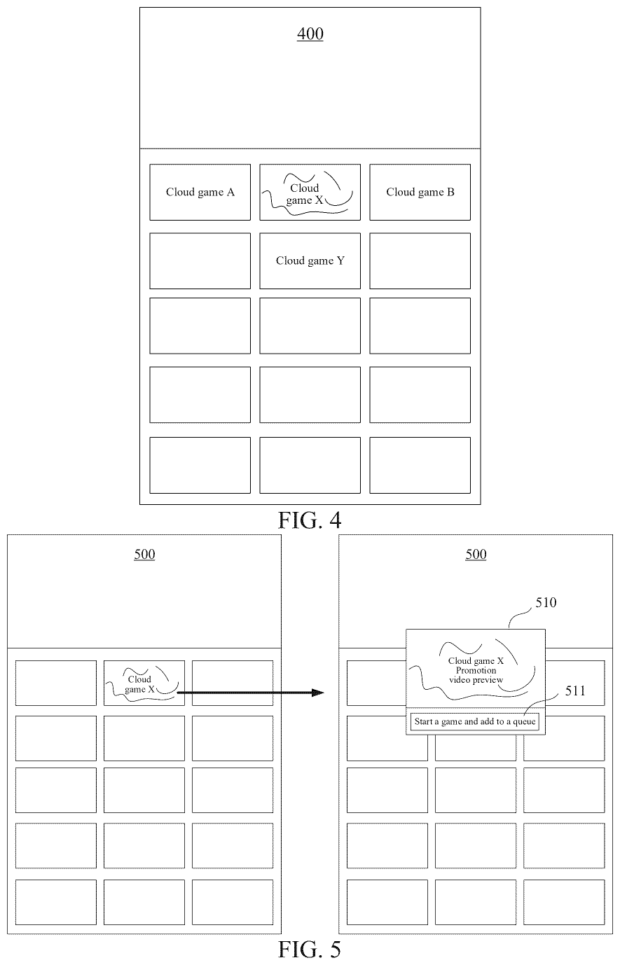

Schematically, FIG. 4 shows a schematic interface diagram of an object exhibition interface 400. The object exhibition interface includes a plurality of cloud games (where each block represents a cloud game, and not all cloud games are shown in the figure) such as cloud game A, cloud game B, cloud game X, and cloud game Y.
Operation 321: Receive a second selection operation on a first cloud game among a plurality of cloud games, and display a first object presentation window corresponding to the first cloud game.

Schematically, the first cloud game is any one of the plurality of cloud games, and is a cloud game selected by the first account at a current moment.

In some embodiments, the second selection operation on the first cloud game is implemented as at least one of trigger operation forms such as a click/tap operation, a long-press operation, and a voice trigger operation. Schematically, an example in which the second selection operation is a long-press operation is used for description. The long-press operation on the first cloud game is received, to display the first object presentation window corresponding to the first cloud game.

Schematically, the first object presentation window is configured for presenting related introduction information of the first cloud game, for example, presenting a functional introduction of the first cloud game, or presenting a historical excellent battle animation of the first cloud game.

In an exemplary embodiment, a service preview animation corresponding to the first cloud game is played within the first object presentation window.

Schematically, the service preview animation is an animation made by the first cloud game officially. Alternatively, the service preview animation is a battle animation of historical battle players of the first cloud game. The service preview animation is configured for representing a game effect when participating in the first cloud game, so that the first account can more intuitively learn information such as a game condition and a game function within the first cloud game.

In some embodiments, a click/tap operation on the first cloud game among the plurality of cloud games is received, and queuing prompt information is displayed in response to the first cloud game being in a queuing state. The queuing prompt information is configured for prompting, by using the long-press operation, a player to add to a first service queue corresponding to the first cloud game. In some embodiments, the queuing state is configured for representing that the first account temporarily cannot directly enter a cloud game, and needs to wait to enter the cloud game by adding to a service queue.

In some embodiments, a click/tap operation on the first cloud game among the plurality of cloud games is received, and game start prompt information is displayed in response to the first cloud game being not in a queuing state. The game start prompt information is configured for prompting that the player does not need to queue up for a current game, and whether to directly enter the game.

In some embodiments, a game interface of the first cloud game is displayed in response to a trigger operation on a start control in the game start prompt information. Alternatively, an object arrangement state is displayed in response to a trigger operation on a queuing control in the game start prompt information. To be specific, the first cloud game is not entered temporarily, but the first account is added to the first service queue corresponding to the first cloud game. In some embodiments, in response to the first cloud game not being in a queuing state after a preset time period, the game start prompt information is displayed again.

The foregoing is merely an illustrative example. This is not limited in this embodiment of this application.
Operation 322: Receive a trigger operation on a first queuing control in the first object presentation window as a first selection operation.

Schematically, the first object presentation window includes a first queuing control. The first queuing control is configured for adding the first account to a first service queue corresponding to the first cloud game. Therefore, a trigger operation on the first queuing control is used as a first selection operation.

The trigger operation is implemented as at least one of trigger operations such as a click/tap operation, a long-press operation, and a voice trigger operation.

Schematically, FIG. 5 shows a schematic interface diagram of performing a first selection operation on a first cloud game in an object exhibition interface 500. Using an example in which the first cloud game is cloud game X, a second selection operation (for example, long-pressing cloud game X) on cloud game X is received, and a first object presentation window 510 is displayed.

Schematically, a promotion video preview (service preview animation) of cloud game X is played on the first object presentation window 510. In addition, the first object presentation window 510 includes a first queuing control 511. The first queuing control 511 displays an operation prompt (Start a game and add to a queue). A trigger operation on the first queuing control 511 is received as a first selection operation.

Operation 323: Receive a dragging operation on the first cloud game among the plurality of cloud games as the first selection operation.

Schematically, the dragging operation is configured for representing a dragging process of a trigger region corresponding to the first cloud game, and further, a dragging process of dragging the trigger region to a preset region is used as the first selection operation.

Schematically, the trigger region and the preset region are regions that are set in advance.

In an exemplary embodiment, an object arrangement window is displayed on the object exhibition interface. The object arrangement window is configured for displaying the object arrangement state.

In some embodiments, the object arrangement window is a window displayed after the first account performs the first selection operation on a cloud game within the object exhibition interface.

Schematically, before the first account performs the first selection operation on the first cloud game, the first account already performs the first selection operation on another cloud game in the object exhibition interface, and an object exhibition window is displayed in the object exhibition interface based on the previous first selection operation. For example, after the first selection operation is performed based on the first account for the first time, the object exhibition window is displayed in the object exhibition interface, so that an object exhibition result can be displayed by using the object exhibition window.

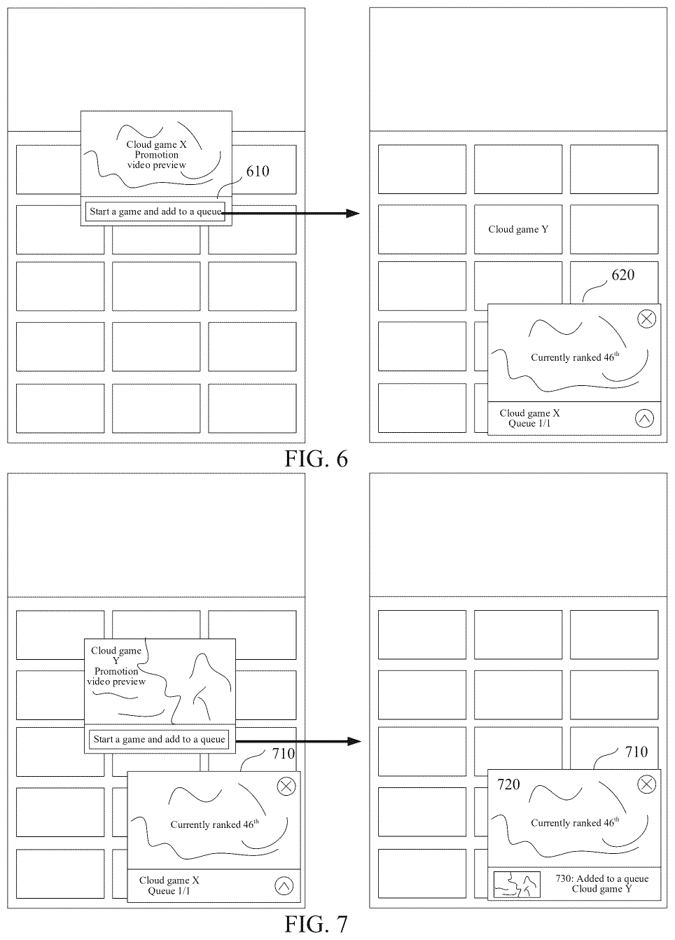

FIG. 6 shows a schematic interface diagram of displaying an object arrangement window through a first selection operation. Schematically, an example in which cloud game X is a 1^{st} cloud game selected by the first account is used. A first selection operation (a trigger operation is performed on a first queuing control 610 therein) is performed on cloud game X, so that an object arrangement window 620 is displayed. A service preview animation corresponding to cloud game X is played in the object arrangement window, and “Queue 1/1” is further displayed, to indicate that one cloud game, namely cloud game X, is selected by the first account currently.

In some embodiments, the object arrangement window is a floating window displayed within the object exhibition interface in advance.

Schematically, the object exhibition window is displayed in the object exhibition interface in advance. Regardless of whether the first account performs the first selection operation on the cloud game within the object exhibition interface, a display status of the object arrangement window is not affected, but content displayed within the object arrangement window is changed. For example, when the first account performs the first selection operation on a cloud game, the cloud game and a corresponding account queuing order are additionally displayed within the object arrangement window.

In some embodiments, the object arrangement window is a window displayed based on a process in which the first account performs the first selection operation on a cloud game within the object exhibition interface.

Schematically, an example in which the first selection operation is a long-press and dragging operation is used. In a process in which the first account performs the long-press operation on the first cloud game within the object exhibition interface, the object arrangement window is displayed in the object exhibition interface, so that the first account can drag the first cloud game into the object arrangement window displayed based on the long-press operation. In some embodiments, after the long-press and dragging operation ends, displaying of a display status of the object arrangement window in the object exhibition interface may be canceled.

In an exemplary embodiment, a dragging operation of dragging the first cloud game to the object arrangement window is received as the first selection operation.

Schematically, the object arrangement window is used as a specified region under the dragging operation, and the first selection operation is completed by using a dragging process of dragging the first cloud game to the object arrangement window.

As shown in FIG. 7, an object arrangement state corresponding to a first account is displayed within an object arrangement window 710, indicating that the first account has performed a first selection operation on cloud game X. After the first account performs the first selection operation on cloud game Y, “Added to a queue of cloud game Y” is displayed within the object arrangement window 710, indicating that the first account is added to a service queue corresponding to cloud game Y.

The foregoing is merely an illustrative example. This is not limited in this embodiment of this application.
Operation 330: Display an object arrangement state in response to the first selection operation.

The object arrangement state includes at least one cloud game selected by the first account. The at least one cloud game includes the first cloud game. The object arrangement state is configured for presenting a queuing status of the first account in the at least one cloud game.

In some embodiments, to avoid overload of running of a cloud server corresponding to the first cloud game, the cloud server usually has a user bearing limitation. The user bearing limitation corresponds to the first cloud game.

In some embodiments, the user bearing limitation is considered as a condition on the number of users participating in the cloud game in the first service queue.

In some embodiments, after the first account performs the first selection operation on the first cloud game, the first account is added to the first service queue. If the first account in the first service queue does not reach a user bearing limitation, the first account may enter the cloud game based on the first selection operation. If the first account in the first service queue reaches the user bearing limitation, the object arrangement state is displayed based on the condition limitation of the number of users being reached.

In an exemplary embodiment, a service preview animation is displayed based on a queuing status of the first account in at least one service queue in response to the first selection operation. The service preview animation is a game picture corresponding to the cloud game. The object arrangement state includes the service preview animation. The at least one service queue includes the first service queue corresponding to the first cloud game. To be specific, in a queuing process of the first account, a user can preview a game picture of a cloud game, to quickly learn game content of the cloud game, thereby improving transmission efficiency of interface information. In addition, because the user previews the game picture of the cloud game at the queuing stage, the user has some understanding of the game content, and in a playing process, playing efficiency can be improved based on the learned game content in advance, thereby improving the service efficiency when the cloud game platform provides a game service of the cloud game to the user.

Schematically, after the first selection operation is performed on the first cloud game, the first account is added to the first service queue corresponding to the first cloud game. The first selection operation may have been performed on a plurality of cloud games based on the first account. Therefore, the first account may be added to a plurality of service queues.

In some embodiments, account queuing orders respectively corresponding to the first account in the at least one service queue are compared, to display a service preview animation according to the queuing orders.

The account queuing order is configured for representing a queuing status of the first account in a service queue corresponding to the cloud game. For example, the first account is added to service queues respectively corresponding to three cloud games. If ranked 16^{th} in service queue 1 corresponding to cloud game A, an account queuing order of the first account in service queue 1 is 16. If ranked 33^{th} in service queue 2 corresponding to cloud game B, an account queuing order of the first account in service queue 2 is 33. If ranked 8^{th} in service queue 3 corresponding to cloud game C, an account queuing order of the first account in service queue 3 is 8.

In some embodiments, a service preview animation corresponding to the first cloud game is displayed when a first queuing order of the first account in the first service queue precedes a queuing order of the first account in another service queue. To be specific, a service preview animation of a cloud game queuing at the head is first displayed instead of displaying service preview animations of all the cloud games, so that waste of application resources can be reduced, and a user can also focus on the cloud game queuing at the head. In addition, the service preview animation usually has a relatively small volume, and occupies relatively few bandwidth and server resources during playback, which is beneficial to optimization of system performance.

Schematically, after account queuing orders respectively corresponding to the first account in the plurality of service queues are compared, a service queue having a smallest queuing order is determined, and a cloud game corresponding to the service queue is determined, to display a service preview animation corresponding to the cloud game. To be specific, a service preview animation corresponding to the first cloud game may be displayed when a first queuing order of the first account in the first service queue precedes a queuing order of the first account in another service queue.

For example, if the account queuing order of the first account in service queue 1 is 16, the account queuing order in service queue 2 is 33, and the account queuing order in service queue 3 is 8, cloud game C corresponding to service queue 3 is determined, and a service preview animation corresponding to cloud game C is displayed.

As shown in FIG. 7, an object arrangement window 710 includes an animation display region 720 for displaying a service preview animation. Because the ranking of the first account in a service queue corresponding to cloud game X is 46 (ranking 46^{th} currently), preceding the ranking 84 of the first account in a service queue corresponding to cloud game Y (shown in the figure), a service preview animation corresponding to cloud game X is displayed in the animation display region 720 for displaying the service preview animation, to more intuitively represent that the first account is at a higher ranking in the service queue corresponding to cloud game X at a current moment, and is more likely to successfully queue for cloud game X.

The foregoing is merely an illustrative example. This is not limited in this embodiment of this application.

In an exemplary embodiment, a first object identifier corresponding to the first cloud game is displayed in an object arrangement window for displaying the object arrangement state.

Schematically, when the object arrangement state is displayed, the object arrangement state is displayed on the object arrangement window, and a first object identifier corresponding to the first cloud game is displayed on the object arrangement window based on the first selection operation performed by the first account on the first cloud game. The first object identifier is configured for representing that the first account is added to the first service queue corresponding to the first cloud game.

Schematically, as shown in FIG. 7, based on the first cloud game being any one of a plurality of cloud games, an example in which the first cloud game is cloud game Y is used. After the first account performs the first selection operation on cloud game Y, “Added to a queue of cloud game Y” is displayed within the object arrangement window 710. The prompt is considered as a first object identifier 730. The first object identifier 730 can present a service queue of cloud game Y to which the first account is added.

In some embodiments, in response to receiving a first selection operation on another cloud game before receiving a first selection operation on a first cloud game, a first object identifier corresponding to the first cloud game is displayed in an object arrangement window for displaying an object arrangement state.

At least one cloud game in the object arrangement state includes another cloud game.

Schematically, when a first selection operation on another cloud game is not received before the first selection operation on the first cloud game is received, a second object identifier corresponding to the first cloud game is displayed in the object arrangement window for displaying the object arrangement state. The second object identifier is configured for representing an account queuing order of the first account in the first service queue corresponding to the first cloud game. For example, the first cloud game is a 1^{st} cloud game selected by the first account, and the first cloud game and an account queuing order corresponding to the first cloud game are displayed in the object arrangement window based on the first selection operation.

Schematically, when the first selection operation on the first cloud game is received before the first selection operation on the first cloud game is received, the second object identifier corresponding to the first cloud game is not directly displayed in the object arrangement window for displaying the object arrangement state, but the first object identifier corresponding to the first cloud game is first displayed in the object arrangement window for displaying the object arrangement state, to represent that the first account is added to the first service queue corresponding to the first cloud game.

In an exemplary embodiment, when a display duration of the first object identifier in the object arrangement window reaches a preset duration, an object presentation control is displayed in the object arrangement window, and in response to the object presentation control receiving a trigger operation, the object arrangement state is displayed in an expanded manner. To be specific, an object presentation control for displaying the object arrangement state in an expanded manner is provided for a user. To be specific, by displaying the first object identifier for the preset duration, obtaining information of the first object identifier by the user can be ensured. After it is indicated by using the first object identifier that the first account has been added to the first service queue corresponding to the first cloud game, the user may display the object arrangement state in an expanded manner by using the object presentation control, thereby navigating the object arrangement state by using the object presentation control, and simplifying an interface design.

Schematically, after the first object identifier is displayed on the object arrangement window, statistics on a display duration of the first object identifier are collected, and the display duration is compared with a preset duration that is set in advance. For example, the preset duration is 2 seconds.

In some embodiments, when the display duration reaches the preset duration, the object presentation control is displayed in the object arrangement window, to display an object arrangement state of at least one cloud game in an expanded manner. Schematically, an account queuing order respectively corresponding to at least one cloud game is displayed in an expanded manner.

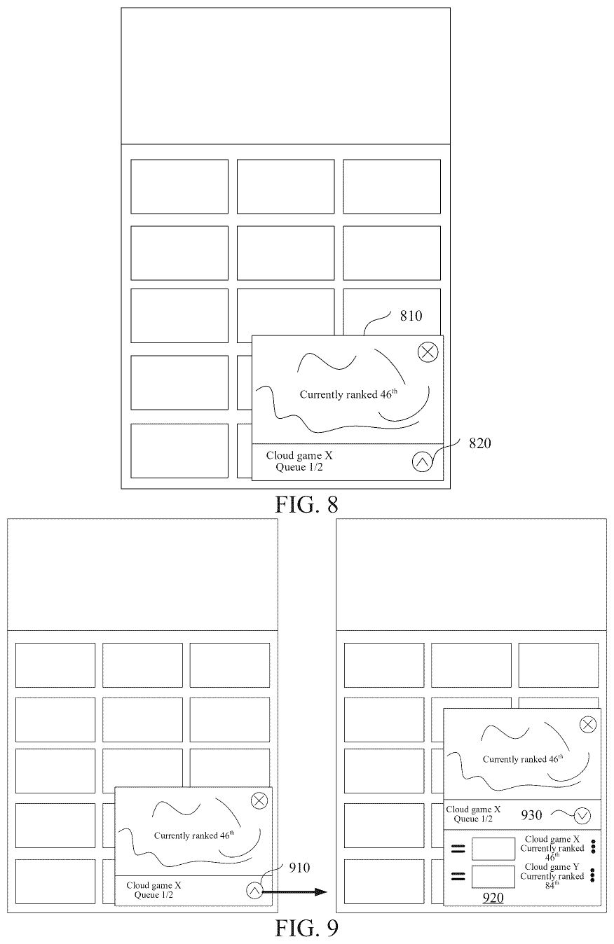

Schematically, when the display duration of the first object identifier 730 shown in FIG. 7 on the object exhibition interface reaches the preset duration, an interface shown in FIG. 8 is displayed. An object presentation control 820 is displayed within an object arrangement window 810, where “Queue 1/2” is configured for representing that a first account has performed a first selection operation on two cloud games. “Cloud game X” is configured for representing that a service preview animation corresponding to cloud game X is displayed in a current object exhibition interface. Text displayed in the service preview animation is: currently ranked 46^{th} in a queue, representing that a current account queuing order of the first account in cloud game X is 46, and so on.

In some embodiments, based on a trigger operation on the object expansion control, at least one service object and an account queuing order respectively corresponding to the at least one service object are displayed in an expanded manner.

As shown in FIG. 9, after a trigger operation is performed on an object presentation control 910 therein, an object queuing order 920 is displayed in an expanded manner, where “Cloud game X-currently ranked 46^{th} in a queue” represents that the first account is ranked 46^{th} in a service queue corresponding to cloud game X. Similarly, “Cloud game Y-currently ranked 84^{th} in a queue” represents that the first account is ranked 84^{th} in a service queue corresponding to cloud game Y, and so on.

Schematically, as shown in FIG. 9, an object thumbnail control 930 is further shown. Based on a trigger operation on the object thumbnail control 930, an interface before the object presentation control 910 is triggered may alternatively be restored to be displayed.

The foregoing is merely an illustrative example. This is not limited in this embodiment of this application.

In an exemplary embodiment, the object arrangement state is displayed in response to the first selection operation and to that the first account satisfies a preset account condition.

Schematically, the preset account condition is an account condition that is set in advance. For example, the preset account condition is that an account belongs to a very important person (VIP). Alternatively, the preset account condition is that an account belongs to a super very important person (SVIP). Alternatively, the preset account condition is that an account level exceeds a preset level (such as level 10 or level 30). Alternatively, the preset account condition is that an account life exceeds a preset life (such as 3 years or 5 years).

In some embodiments, after the first selection operation is received, the first account is compared with the preset account condition. When the first account satisfies the preset account condition, an object queuing order is displayed.

In an exemplary embodiment, in response to the first selection operation and to that the first account does not satisfy the preset account condition, service queue prompt information is displayed based on a queuing status of the first account in another service queue.

In some embodiments, after the first selection operation is received, the first account is compared with the preset account condition. When the first account does not satisfy the preset account condition, the queuing status of the first account in the another service queue is determined.

Schematically, if it is detected that the first account is also queued up in a service queue corresponding to another cloud game, the displayed service queue prompt information is configured for prompting the first account to exit the another service queue. To be specific, if the first account does not satisfy the preset account condition, the first account can only perform a queuing process in a service queue corresponding to one cloud game. If it is detected that the first account is not queued up in the service queue corresponding to another cloud game, the displayed service queue prompt information is configured for prompting that the first account can only be queued up in a current service queue, and cannot perform a queuing process in the service queue corresponding to another cloud game.

The foregoing is merely an illustrative example. This is not limited in this embodiment of this application.

In conclusion, by means of a first selection operation, a first account can be added to a service queue corresponding to at least one cloud game at the same time, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using an object arrangement state, thereby greatly improving a probability of participating in a game by the first account in time, enabling a player to participate in a cloud game more efficiently, and improving human-computer interaction efficiency.

In this embodiment of this application, a first cloud game is dragged to an object queuing window by means of a dragging operation, which is beneficial to more intuitively and vividly presenting a process of adding a first account to a first service queue corresponding to the first cloud game. The first account can be added to the first service queue corresponding to the first cloud game more accurately by means of a click/tap operation. In addition, a service preview animation presented within the object queuing window also helps the first account to more intuitively learn a queuing status of the current first account in service queues corresponding to a plurality of cloud games, thereby improving human-computer interaction efficiency.

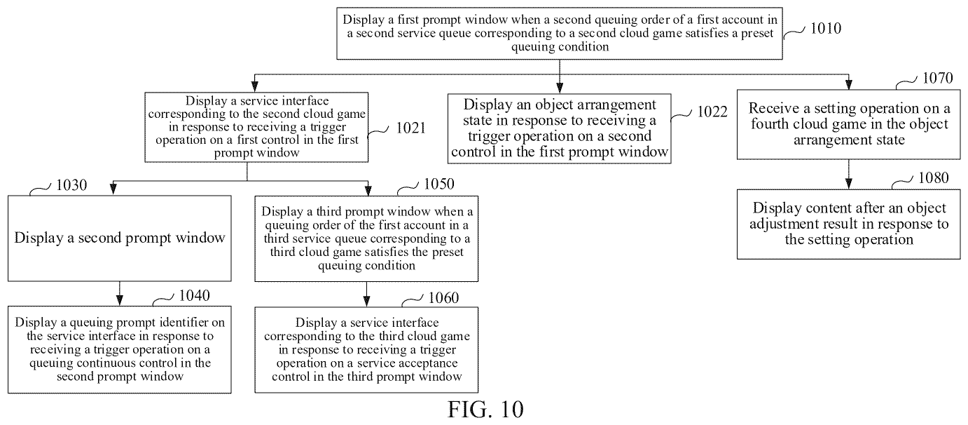

In an exemplary embodiment, after the object arrangement state is displayed, a prompt window for prompting the first account to receive a game service is displayed according to a queuing order of the first account in a service queue respectively corresponding to at least one cloud game, to more efficiently find a cloud game capable of providing a game service by performing a process of simultaneously queuing up for at least one cloud game. Schematically, as shown in FIG. 10, after operation 230 shown in FIG. 2, the method may further be implemented as the following operations 1010 to 1080.
Operation 1010: Display a first prompt window when a second queuing order of a first account in a second service queue corresponding to a second cloud game satisfies a preset queuing condition.

The at least one cloud game includes the second cloud game. Schematically, the second cloud game is any cloud game in an object arrangement state. The service queue corresponding to the second cloud game is the second service queue. The second queuing order is configured for representing an account queuing order of the first account in the second service queue.

In some embodiments, the second queuing order of the first account in the second service queue is periodically detected. Alternatively, the second queuing order of the first account in the second service queue is detected in real time.

Schematically, in addition to transmitting the object arrangement state by a terminal, a server may detect, in real time, an account queuing order of the first account in a service queue respectively corresponding to at least one cloud game. If detecting that the second queuing order of the first account in the second service queue satisfies the preset queuing condition, first prompt information is transmitted to the terminal, to display a first prompt window on the terminal.

The preset queuing condition is a queuing condition that is set in advance. In some embodiments, the preset queuing condition is that the account queuing order of the first account in the service queue is the first. Alternatively, the preset queuing condition is that the account queuing order of the first account in the service queue is the first three.

The first prompt window is configured for prompting the first account to accept a game service provided by the second cloud game. The first prompt information is configured for representing information that is transmitted by the server to the terminal and prompts the first account to receive a service provided by the second cloud game.

Schematically, the first prompt window is configured for prompting the first account to enter the second cloud game to participate in a game process.

In an exemplary embodiment, the first prompt window is displayed when the second queuing order indicates that the first account is at the head of the second service queue.

Schematically, when the server detects that the first account is at the head of the second service queue, it is considered that the second queuing sequence satisfies the preset queuing condition, so that the server transmits the first prompt information to the terminal, to display the first prompt window on the terminal.

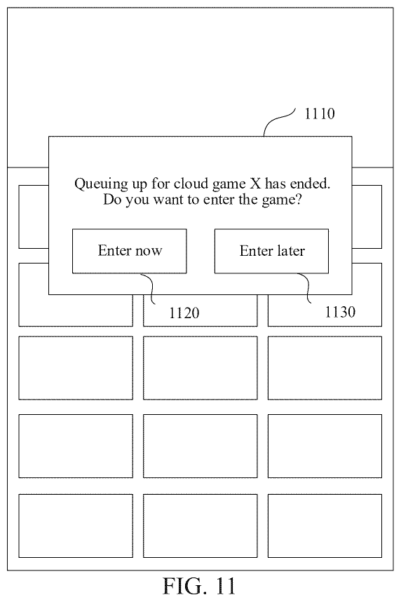

FIG. 11 shows a schematic interface diagram of displaying a first prompt window. A first prompt window 1110 displayed therein includes text content “Queuing up for cloud game X has ended. Do you want to enter the game?”. To be specific, the first account is at the head of a service queue corresponding to cloud game X (which is considered as a second cloud game).
Operation 1021: Display a service interface corresponding to the second cloud game in response to receiving a trigger operation on a first control in the first prompt window.

Schematically, the first control is a trigger control within the first prompt window. The first control is configured for representing that the first account accepts a game service provided by the second cloud game.

As shown in FIG. 11, a first prompt window includes a first control 1120, where prompt text “Enter now” is configured for representing that the first account accepts a game service provided by a second cloud game. In some embodiments, based on a trigger operation on the first control, a service interface corresponding to the second cloud game is displayed. To be specific, the first account accepts a game service provided by the second cloud game, and a game process is started.
Operation 1022: Display an object arrangement state in response to receiving a trigger operation on a second control in the first prompt window.

Schematically, the second control is also a trigger control within the first prompt window. The second control is configured for representing that the first account temporarily does not accept the game service provided by the second cloud game.

As shown in FIG. 11, the first prompt window includes a second control 1130, where prompt text “Enter later” is configured for representing that the first account temporarily does not accept a game service provided by the second cloud game. In some embodiments, an object arrangement state is displayed based on a trigger operation on the second control. Alternatively, an object exhibition interface is displayed.

In some embodiments, after the trigger operation is performed on the second control, queuing of the first account in the second service queue is automatically canceled. To be specific, the first account is deleted from the second service queue. Alternatively, after the trigger operation is performed on the second control, the first account is automatically moved backward in the second service queue by a preset number of positions. For example, the preset number of positions is 10. When the first account satisfies the preset queuing condition in the second service queue, but the terminal receives the trigger operation on the second control from the first account, the first account is temporarily not deleted from the second service queue, and the first account is automatically moved backward by 10 positions, to remind the first account to enter the second cloud game again after 10 positions.

In some embodiments, when the trigger operation performed by the first account on the second control reaches a preset trigger count, the first account is deleted from the second service queue. For example, when the trigger operation performed by the first account on the second control reaches a preset trigger count of 5, it is considered that the first account does not want to enter the second cloud game, and the first account is automatically deleted from the second service queue.

The foregoing is merely an illustrative example. This is not limited in this embodiment of this application.
Operation 1030: Display a second prompt window.

In an exemplary embodiment, after operation 1021 is performed, a queuing process for a service queue corresponding to another cloud game continues by default. Alternatively, after operation 1021 is performed, operations 1030 to 1040 are performed.

In some embodiments, after a service interface corresponding to the second cloud game is displayed, a second prompt window is displayed. Alternatively, the second prompt window is displayed when the service interface corresponding to the second cloud game is displayed and duration of staying in the service interface reaches a preset duration.

The second prompt window is configured for prompting the first account to adjust a queuing continuous state of another cloud game.

Schematically, the queuing continuous state is configured for representing a status in which the first account continues to queue up in a service queue corresponding to another cloud game.

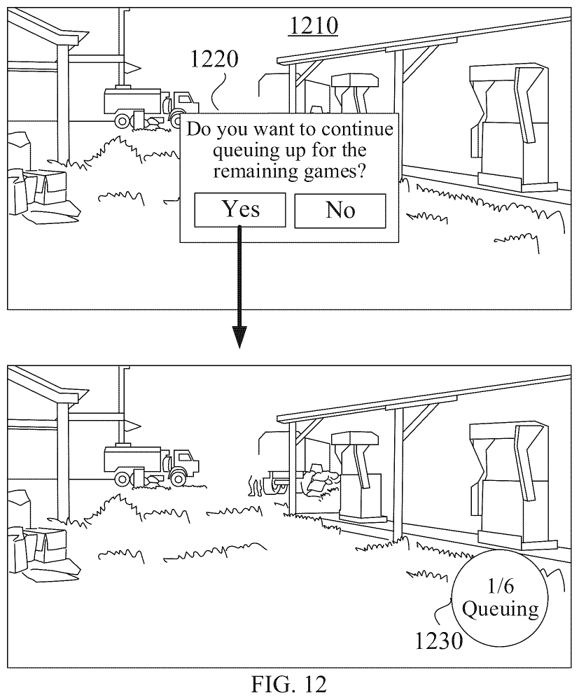

FIG. 12 shows a schematic interface diagram of a second prompt window. A second prompt window 1220 is displayed on a service interface 1210. The second prompt window 1220 includes prompt text “Do you want to continue queuing up for the remaining games?”.
Operation 1040: Display a queuing prompt identifier on the service interface in response to receiving a trigger operation on a queuing continuous control in the second prompt window.

The queuing continuous control is configured for representing that the first account continues to queue up for at least one other cloud game.

Schematically, the queuing prompt identifier is an identifier in the second prompt window. As shown in FIG. 12, the second prompt window 1220 includes a “Yes” control and a “No” control. The “Yes” control is the queuing continuous control. After a trigger operation is performed on the “Yes” control, a queuing prompt identifier 1230 is displayed on the service interface 1210.

The queuing prompt identifier is configured for representing a queuing status of the first account in another cloud game.

Schematically, the queuing prompt identifier may be implemented in any one of a plurality of forms such as a text form, a circle form, and a floating window form. As shown in FIG. 12, the queuing prompt identifier 1230 is implemented in a form of a small floating ball, where “1/6 queuing” is configured for indicating that the first account currently performs a queuing process in service queues corresponding to six cloud games.

In some embodiments, a trigger operation on the queuing prompt identifier is received to display a remaining queuing order, including at least one cloud game that is not quit queuing by the first account. A deletion operation on a fifth cloud game in the remaining queuing order is received, and the first account is deleted from a service queue corresponding to the fifth cloud game. To be specific, cloud games that are queuing up may be continued to be screened by using the queuing prompt identifier, thereby simplifying a queuing manner and the like.

As shown in FIG. 12, after a trigger operation is performed on the “No” control, it is considered that the first account quits a queuing process for another cloud game.

Operation 1050: Display a third prompt window when a queuing order of the first account in a third service queue corresponding to a third cloud game satisfies the preset queuing condition.

At least one cloud game includes the third cloud game. The third cloud game is a cloud game in the at least one cloud game other than the second cloud game. The third service queue is a service queue corresponding to the third cloud game.

Schematically, after the service interface is displayed, when the queuing order of the first account in the third service queue corresponding to the third cloud game satisfies the preset queuing condition, a third prompt window is displayed.

In some embodiments, after the first account performs a cloud game process through the first cloud game, and does not quit a queuing process for another cloud game by default, if the queuing order of the first account in the third service queue corresponding to the third cloud game satisfies the preset queuing condition, the third prompt window is displayed. Alternatively, after the first account performs a cloud game process through the first cloud game and manually selects, through the second prompt window, to continue a queuing process for another cloud game, if the queuing order of the first account in the third service queue corresponding to the third cloud game satisfies the preset queuing condition, the third prompt window is displayed.

The third prompt window is configured for prompting the first account to accept a game service provided by the third cloud game.
Operation 1060: Display a service interface corresponding to the third cloud game in response to receiving a trigger operation on a service acceptance control in the third prompt window.

Schematically, the third prompt window includes a service acceptance control. The service acceptance control is configured for entering the third cloud game to accept a game service provided by the third cloud game, to display a service interface corresponding to the third cloud game. For example, the third cloud game is jumped to for displaying a corresponding service interface.

In some embodiments, a service interface corresponding to the second cloud game is displayed in response to receiving a trigger operation on a service denial control in the third prompt window.

Schematically, the third prompt window further includes a service denial control. The service denial control is configured for indicating that if the first account does not accept the game service provided by the third cloud game, the service interface corresponding to the second cloud game continues to be displayed.
Operation 1070: Receive a setting operation on a fourth cloud game in the object arrangement state.

The setting operation is configured for adjusting at least one of an object display content and an account queuing content. Schematically, the object display content is configured for representing an arrangement display status of at least one cloud game in the object arrangement state. The account queuing content is configured for representing a queuing status of the first account in at least one cloud game.

In some embodiments, an object setting operation on the fourth cloud game in the object arrangement state is received. The object setting operation is configured for adjusting an arrangement display status of at least one cloud game in the object arrangement state.

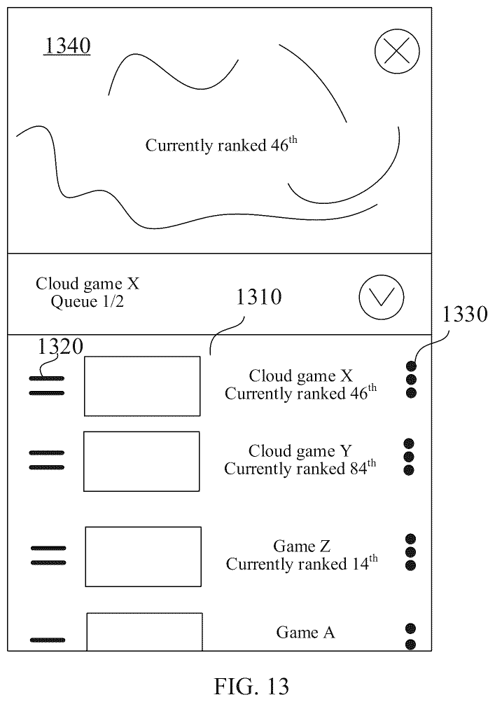

As shown in FIG. 13, an object arrangement state 1310 is displayed. Using an example in which the fourth cloud game is cloud game X, a dragging trigger operation on a movement control 1320 corresponding to cloud game X in the object arrangement state is received as an object setting operation, to move an arrangement sequence of cloud game X in the object arrangement state. For example, cloud game X is moved to follow cloud game Y.

In some embodiments, an account setting operation on the fourth cloud game in the object arrangement state is received. The account setting operation is configured for adjusting a queuing status of the first account in at least one cloud game.

As shown in FIG. 13, an object arrangement state 1310 is displayed. Using an example in which the fourth cloud game is cloud game Y, a dragging trigger operation on a setting control 1330 corresponding to cloud game Y in the object arrangement state is received as an account setting operation. The setting control 1330 includes a plurality of account setting functions such as a deletion function and a pause function. The deletion function is configured for removing the first account from a service queue corresponding to the cloud game. The pause function is configured for maintaining a queuing sequence (for example, maintaining at a 10th position) of the first account in the service queue corresponding to the cloud game. The first account may be removed from the service queue corresponding to cloud game Y by triggering the setting control 1330 and selecting the deletion function.

Schematically, a deletion operation on a fourth cloud game in the object arrangement state is received. The deletion operation is configured for canceling queuing of the first account in a fourth service queue corresponding to the fourth cloud game. To be specific, a user may cancel, through the deletion operation, queuing of an account in a service queue corresponding to a cloud game, thereby avoiding unnecessary waiting time of the user, not only improving user experience, but also saving resource consumption costs of a cloud game platform.

In an exemplary embodiment, a click/tap operation on the cloud game in the object arrangement state is received, and a preview service animation of the cloud game is displayed in a video preview region. Schematically, as shown in FIG. 13, a click/tap operation on cloud game Y is received, and a preview service animation corresponding to cloud game Y is displayed in a video preview region 1340. In some embodiments, an account queuing order corresponding to cloud game Y (for example, the first account is ranked 84^{th} in a service queue corresponding to cloud game Y) may further be displayed in the video preview region 1340.
Operation 1080: Display content in an object adjustment result in response to the setting operation.

Schematically, displaying of the fourth cloud game and an account queuing order corresponding to the fourth cloud game is canceled in the object arrangement state in response to the deletion operation.

The foregoing is merely an illustrative example. This is not limited in this embodiment of this application.

In conclusion, by means of a first selection operation, a first account can be added to a service queue corresponding to at least one cloud game at the same time, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using an object arrangement state, thereby greatly improving a probability of participating in a game by the first account in time, enabling a player to participate in a cloud game more efficiently, and improving human-computer interaction efficiency.

In this embodiment of this application, after an object arrangement state for presenting a queuing status of at least one cloud game is displayed, a prompt window for prompting a player to receive a cloud game service may be displayed according to a queuing order of a first account in a service queue corresponding to a cloud game. In addition, when a cloud game is played, a queuing process can be continued for another cloud game, thereby greatly improving participation of the player in the cloud game. In addition, the player can match the favored cloud game with more probability, not only game play methods are enriched, but also human-computer interaction efficiency is improved, thereby avoiding a problem of data resource waste caused by continuous entry and quit of the cloud game.

In an exemplary embodiment, when the first account is implemented as a common account, the first account is restricted from performing a queuing process on one cloud game among a plurality of cloud games. For example, when the first account queues up for cloud games based on the terminal, if one of the cloud games is selected first to be started and queued up, a back-end (server) records the cloud game for which the current first account queues up. When the first account is switched to another cloud game, the current cloud game needs to be quit, the another cloud game needs to be queued up again, and a quantity of positions in the queue is updated. To be specific, there is a one-to-one relationship between the first account and the cloud game.

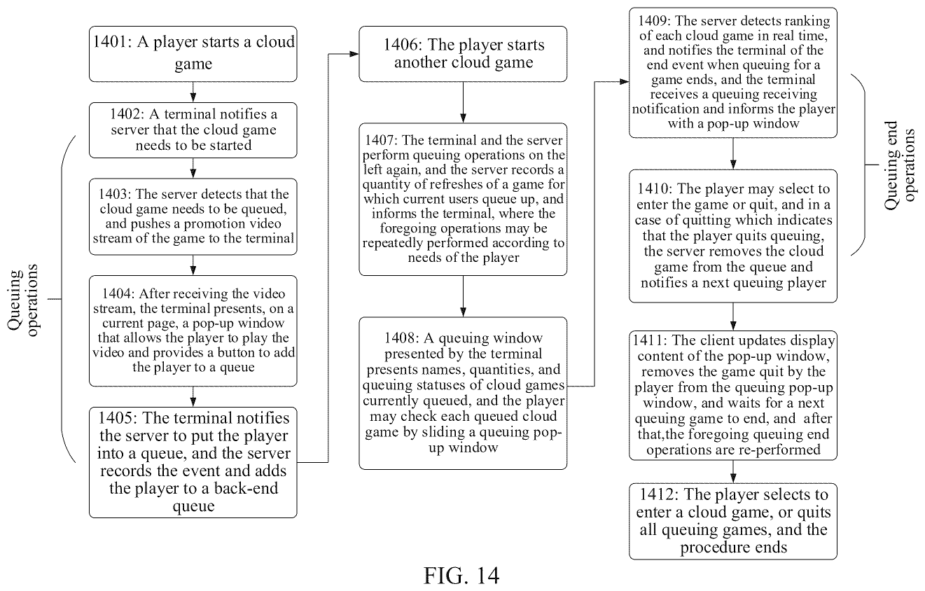

When the first account is implemented as an SVIP account, the first account can perform a queuing process on a plurality of cloud games based on the foregoing cloud game selection method. The foregoing cloud game selection method may alternatively be referred to as “a method in which a terminal is used as a cloud game control device and an SVIP player implements simultaneous queuing for a plurality of opened games”. Schematically, the cloud game selection method may further be implemented as a procedure as shown in FIG. 14, including operations 1401 to 1412.
Operation 1401: A player starts a cloud game.

Schematically, a player logs into a terminal with a first account. A cloud game application is installed in the terminal. The cloud game application is an application provided by a cloud platform. An object exhibition interface is displayed based on a trigger operation of the player on the terminal. The object exhibition interface includes a plurality of cloud games provided by the cloud platform.

When the player selects any one cloud game (for example, a first cloud game) from a plurality of cloud games, the player starts the cloud game.
Operation 1402: A terminal notifies a server that the cloud game needs to be started.

Schematically, after a user starts a cloud game, the terminal informs the server of a start event of a current first account, to notify the server that the cloud game needs to be started.
Operation 1403: The server detects that the cloud game needs to be queued, and pushes a promotion video stream of the game to the terminal.

Schematically, after the terminal informs the server of the start event of the current first account, the server analyzes a queuing status of the cloud game and an account status of the first account. If a current cloud game does not need to be queued, the cloud game is directly entered. If the current cloud game needs to be queued, it is determined whether the first account is an SVIP. If the first account is not an SVIP, only one cloud game can be queued. If there is a cloud game that has been queued, the user is notified that a previous cloud game needs to be quit before the cloud game can be queued. If the first account is an SVIP, a promotion video (i.e. the foregoing service preview animation) of the game is transmitted to the terminal.
Operation 1404: After receiving the video stream, the terminal presents, on a current page, a pop-up window that allows the player to play the video and provides a button to add the player to a queue.

Schematically, after receiving the video stream, the terminal presents a pop-up window (an object presentation window shown in FIG. 5) on an object exhibition interface, and plays the video stream on the pop-up window. Alternatively, a pop-up window is presented on the object exhibition interface, and the video stream is played based on the player performing a playing operation (for example, clicking/tapping a start control) on the video stream on the pop-up window.

In some embodiments, a queuing button (for example, a first queuing control 511 shown in FIG. 5) is presented below the pop-up window, and the player may click/tap the queuing button to add the current cloud game to the queue.

Schematically, as shown in FIG. 5, in a front-page game list (an object exhibition interface 500) of the terminal, the player presses a cloud game such as cloud game X, and a pop-up box (a first object presentation window 510) is popped up. An upper part of the pop-up box is a promotion video of the cloud game, and a lower part of the pop-up box is a first queuing control 511 of “Start a game and add to a queue”.

In some embodiments, as shown in FIG. 6, after the player clicks/taps a first queuing control 610 of “Start a game and add to a queue”, a current cloud game is zoomed out to a lower right corner in a form of a floating window (an object arrangement window 620), the cloud game video continues to be played, and a current queuing state (indicating the ranking) is displayed in a picture.
Operation 1405: The terminal notifies the server to put the player into a queue, and the server records the event and adds the player to a back-end queue.

Schematically, the terminal informs the server of the queuing event, and the server records the queuing event of the player and adds the player to the queue of the cloud game. To be specific, the first account is added to a service queue corresponding to the cloud game.

In some embodiments, the foregoing operations 1402 to 1405 are referred to as queuing operations.
Operation 1406: The player starts another cloud game.

Schematically, the player starts a cloud game other than the first cloud game among the plurality of cloud games by using the terminal.

As shown in FIG. 7, if the player continues to start another cloud game, the player may add the cloud game to a queue by using a control “Start a game and add to a queue”, or may press a game cover image and slide (drag) the game cover image to a queuing floating window (an object arrangement window) to perform queuing.

In some embodiments, a game cover of a game that is queued in a game list becomes gray, but the gray gradually becomes colorful as the queuing progresses. For example, when the first account is just added to the cloud game, the first account is ranked 80th, and the cover is gray. As the first account is ranked front, the cover gradually changes from gray to color. Alternatively, when the first account is just added to the cloud game, the first account is ranked 80th, and the cover is gray. When the first account is ranked in the first 10 positions of the cloud game, the cover gradually changes from gray to color.

In some embodiments, when the player adds another cloud game, information corresponding to the cloud game pops up and then automatically disappears after being presented for two seconds, a UI is restored, and at this moment, queue information is changed to 1/2. If more games are added, queue information is presented similarly as, for example, 1/3 or 1/4.

In some embodiments, a UI of a floating window (an object arrangement window) also changes with queuing progress. If the queuing progress of a cloud game is ahead, the floating window UI preferentially plays a promotion video of the cloud game, and the like.

Operation 1407: The terminal and the server perform queuing operations on the left again, and the server records a quantity of refreshes of a game for which current users queue up, and informs the terminal, where the foregoing operations may be repeatedly performed according to the needs of the player.

In some embodiments, the player may select to start another cloud game, and the terminal performs again the queuing operations shown in operations 1402 to 1405. In this case, the server synchronously updates a quantity of queuing games of the player, and notifies the terminal to update and present a user interface (UI).

Schematically, after receiving an update event, the terminal updates, in a displayed queuing pop-up window (for example, an object arrangement window 620 shown in FIG. 6), a quantity of cloud games that are queuing up, rankings (queuing positions) of the cloud games, and a quantity of games for which the first account is queued up.
Operation 1408: A queuing window presented by the terminal presents names, quantities, and queuing statuses of cloud games currently queued, and the player may check each queued cloud game by sliding the queuing pop-up window.

In some embodiments, queuing positions (i.e. the foregoing account queuing orders) of the first account in different cloud games may be separately viewed by sliding a queuing pop-up window (for example, by using an object presentation control shown in FIG. 8).

In some embodiments, the server detects the ranking of each cloud game in real time, and immediately notifies the terminal when the ranking is updated, so that the terminal synchronously updates ranking information. The player may also click a queuing deletion button (for example, a deletion control included under a setting control 1330 in FIG. 13) provided by the pop-up window, and the terminal notifies the server to remove the queuing event of the player for the cloud game from the queue of the server (to be specific, the first account is removed from a service queue corresponding to the cloud game). After the removal succeeds, the terminal synchronously updates presentation of the pop-up window.
Operation 1409: The server detects the ranking of each cloud game in real time, and notifies the terminal of the end event when queuing for a game ends, and the terminal receives a queuing receiving notification and informs the player with a pop-up window.

Schematically, when the ranking of a cloud game ends (for example, the first account is ranked at the head of a service queue corresponding to the cloud game), the server notifies the terminal of the event. After receiving a queuing end event, the terminal presents a queuing end pop-up window (for example, a first prompt window 1110 shown in FIG. 11) on an interface, to inform the player that the player may immediately enter the cloud game. To be specific, queuing of the cloud game ends, and the player is prompted by a pop-up window, so that the player may select whether to enter the cloud game.
Operation 1410: The player may select to enter the game or quit, and when quitting which indicates that the player quits queuing, the server removes the cloud game from the queue and notifies a next queuing player.

Schematically, if the player selects no based on the queuing end pop-up window (to be specific, the player does not enter the cloud game immediately), the terminal informs the server that the player (the first account) has quitted queuing (to be specific, the first account quits queuing in the service queue corresponding to the cloud game), and the server removes the player from the queue (to be specific, the server removes the first account from the service queue corresponding to the cloud game), takes a next queuing player (for example, a second account) at a position, and informs the second account of a queuing end event.

In some embodiments, the foregoing operations 1409 to 1410 are referred to as queuing end operations.
Operation 1411: The client updates display content of the pop-up window, removes the game quit by the player from the queuing pop-up window, and waits for a next queuing game to end, and after that, the foregoing queuing end operations are re-performed after ending.

Schematically, the terminal corresponding to the first account removes the cloud game from the queuing pop-up window corresponding to the first account based on the first account not immediately entering the cloud game, and updates a quantity of queuing games.

In some embodiments, the server continues to detect a ranking status of another cloud game in real time. When queuing for the another cloud game ends, the server also performs the foregoing queuing end operations, and updates a presentation status of the queuing pop-up window according to the selection of the player.
Operation 1412: The player selects to enter a cloud game, or quits all queuing games, and the procedure ends.

Schematically, when the player selects to enter a cloud game, the terminal informs the server of the event, and the server removes other queuing games of the player from the queue and updates a queuing quantity of the player to 0. Alternatively, the terminal is notified according to a process of selectively removing another queued game by the player. The terminal removes the cloud game within the queued pop-up window according to a requirement of the player, enters a game page of the selected cloud game, and receives a game video stream of the server.

Schematically, after entering a cloud game, the player is prompted whether to continue queuing for remaining cloud games. If the player selects to continue queuing up for another game, in a current cloud game process, a queuing status of the another cloud game may be on a game interface in a form of a small floating ball, as shown in a queuing prompt identifier 1230 shown in FIG. 12. After the remaining cloud games are ranked, the player may select to end the current cloud game or hang up the current cloud game, and then switch to another cloud game to participate in the game process.

In some embodiments, if the player selects to quit all the last queuing game when the ranking of the last queuing game ends, the terminal synchronously removes the queued pop-up window (or removes the cloud game in the queued pop-up window), and the server updates a queuing quantity of the player to 0, waits for the player to start another cloud game, to present the queued pop-up window again, or directly enter another cloud game that does not need to be started, or the like.

In an exemplary embodiment, an object arrangement state shown in FIG. 13 is described. If the player clicks/taps a cloud game, a promotion video of the cloud game is played on a top picture, and a queuing status of the currently clicked/tapped cloud game is displayed at the same time.

In addition, an arrangement sequence of the cloud game in an object arrangement state may be moved by using a movement control 1320 shown in FIG. 13. For example, a queue position may be changed by dragging the movement control 1320 up and down. Various account setting functions such as a deletion function and a pause function may be performed by using a setting control 1330 shown in FIG. 13. The deletion function is configured for removing the first account from the service queue corresponding to the cloud game. The pause function is configured for maintaining a queuing sequence of the first account in the service queue corresponding to the cloud game.

The foregoing is merely an illustrative example. This is not limited in this embodiment of this application.

In conclusion, by means of a first selection operation, a first account can be added to a service queue corresponding to at least one cloud game at the same time, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using an object arrangement state, thereby greatly improving a probability of participating in a game by the first account in time, enabling a player to participate in a cloud game more efficiently, and improving human-computer interaction efficiency.

In this embodiment of this application, players of different levels are distinguished. For a common player, a rule that one player queues up for a cloud game is used. For an SVIP player, the SVIP player may autonomously select to queue up for a plurality of cloud games, so that the SVIP player can enter the selected queuing games at a higher speed, thereby shortening the queuing time of the SVIP player, improving the cloud game experience of the SVIP player, facilitating promotion of conversion from the common player into the SVIP player, improving the recall of the cloud game queuing process, and improving the human-computer interaction efficiency.

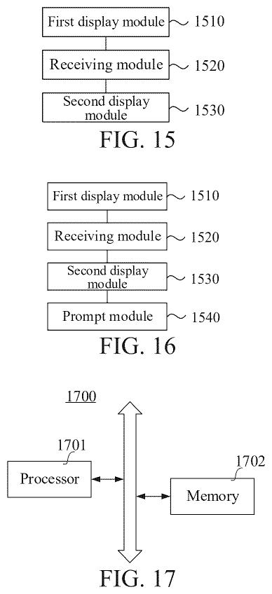

FIG. 15 is a structural block diagram of a cloud game selection apparatus according to an exemplary embodiment of this application. As shown in FIG. 15, the apparatus includes the following parts:
a first display module 1510, configured to display a plurality of cloud games mounted on a cloud game platform, where a first account is logged into the cloud game platform, and the cloud games are configured for providing a game service to the first account;
a receiving module 1520, configured to receive a first selection operation on a first cloud game among the plurality of cloud games, where the first selection operation is configured for adding the first account to a first service queue corresponding to the first cloud game, and the first service queue is configured for representing an account queuing status of the first cloud game when providing the game service; and
a second display module 1530, configured to display an object arrangement state in response to the first selection operation, where the object arrangement state includes at least one cloud game selected by the first account, the at least one cloud game includes the first cloud game, and the object arrangement state is configured for presenting a queuing status of the first account in the at least one cloud game.

In an exemplary embodiment, the second display module 1530 is further configured to display, in response to the first selection operation, the at least one cloud game and an account queuing order respectively corresponding to the at least one cloud game as the object arrangement state, where the account queuing order is configured for representing a queuing status of the first account in a service queue corresponding to the cloud game.

In an exemplary embodiment, the second display module 1530 is further configured to display a service preview animation based on a queuing status of the first account in at least one service queue in response to the first selection operation, where the object arrangement state includes the service preview animation, and the service preview animation is a game picture corresponding to a cloud game.

In an exemplary embodiment, the second display module 1530 is further configured to display a service preview animation corresponding to the first cloud game when a first queuing order of the first account in the first service queue precedes a queuing order of the first account in another service queue.

In an exemplary embodiment, the second display module 1530 is further configured to display a first object identifier corresponding to the first cloud game in an object arrangement window for displaying the object arrangement state, where the first object identifier is configured for representing that the first account is added to the first service queue corresponding to the first cloud game.

In an exemplary embodiment, the second display module 1530 is further configured to display an object presentation control in the object arrangement window when a display duration of the first object identifier in the object arrangement window reaches a preset duration.

The second display module 1530 is further configured to display the object arrangement state in an expanded manner in response to the object presentation control receiving a trigger operation.

In an exemplary embodiment, the receiving module 1520 is further configured to: display an object arrangement window, where the object arrangement window is configured for displaying the object arrangement state; and receive a dragging operation of dragging the first cloud game to the object arrangement window as the first selection operation.

In an exemplary embodiment, the receiving module 1520 is further configured to: receive a second selection operation on the first cloud game among the plurality of cloud games, and display a first object presentation window corresponding to the first cloud game, where the first object presentation window includes a first queuing control, and the first queuing control is configured for adding the first account to a first service queue corresponding to the first cloud game; and receive a trigger operation on the first queuing control in the first object presentation window as the first selection operation.

In an exemplary embodiment, the receiving module 1520 is further configured to play a service preview animation corresponding to the first cloud game within the first object presentation window.

In an exemplary embodiment, the apparatus is configured in a display device. A communication connection relationship is established between the display device and a control device.

The receiving module 1520 is further configured to receive a trigger operation performed by the control device on a first cloud game among the plurality of cloud games as the first selection operation.

As shown in FIG. 16, in an exemplary embodiment, the apparatus further includes:
a prompt module 1540, configured to display a first prompt window when a second queuing order of the first account in a second service queue corresponding to a second cloud game satisfies a preset queuing condition, where the first prompt window is configured for prompting the first account to accept a game service provided by the second cloud game, and the at least one cloud game includes the second cloud game.

In an exemplary embodiment, the prompt module 1540 is further configured to display the first prompt window when the second queuing order indicates that the first account is at the head of the second service queue.

In an exemplary embodiment, the prompt module 1540 is further configured to: display a service interface corresponding to the second cloud game in response to receiving a trigger operation on a first control in the first prompt window, where the first control is configured for representing that the first account accepts a game service provided by the second cloud game; or, display the object arrangement state in response to receiving a trigger operation on a second control in the first prompt window, where the second control is configured for representing that the first account denies a game service provided by the second cloud game.

In an exemplary embodiment, the prompt module 1540 is further configured to: display a second prompt window, where the second prompt window is configured for prompting the first account to adjust a queuing continuous state of another cloud game; and display a queuing prompt identifier on the service interface in response to receiving a trigger operation on a queuing continuous control in the second prompt window, where the queuing continuous control is configured for representing that the first account continues to queue up for at least one another cloud game, and the queuing prompt identifier is configured for representing a queuing status of the first account in the another cloud game.

In an exemplary embodiment, the prompt module 1540 is further configured to display a third prompt window when a queuing order of the first account in a third service queue corresponding to a third cloud game satisfies the preset queuing condition, where the third prompt window is configured for prompting the first account to accept a game service provided by the third cloud game, and the at least one cloud game includes the third cloud game.

In an exemplary embodiment, the prompt module 1540 is further configured to display a service interface corresponding to the third cloud game in response to receiving a trigger operation on a service acceptance control in the third prompt window.

In an exemplary embodiment, the prompt module 1540 is further configured to: receive a deletion operation on a fourth cloud game in the object arrangement state, where the deletion operation is configured for canceling queuing of the first account in a fourth service queue corresponding to the fourth cloud game; and cancel displaying the fourth cloud game and an account queuing order corresponding to the fourth cloud game in the object arrangement state in response to the deletion operation.

In conclusion, by means of a first selection operation, a first account can be added to a service queue corresponding to at least one cloud game at the same time, thereby avoiding a problem that the first account can queue up only in a single cloud game, and consequently, a probability of participating in a game is relatively low. By using the first selection operation, the first account can select a plurality of cloud games to queue up, and a queuing status of the first account queuing up in the plurality of cloud games is viewed in time and accurately by using an object arrangement state, thereby greatly improving a probability of participating in a game by the first account in time, enabling a player to participate in a cloud game more efficiently, and improving human-computer interaction efficiency.

The cloud game selection apparatus provided in the foregoing embodiment is illustrated only with an example of division of the foregoing function modules. In practical applications, the foregoing functions may be allocated to and completed by different function modules according to requirements. To be specific, the internal structure of the apparatus is divided into different function modules to complete all or some of the functions described above. In addition, the cloud game selection apparatus provided in the foregoing embodiments belongs to a same idea as the cloud game selection method embodiments. For a specific implementation process thereof, refer to the method embodiments. Details are not described herein again.

FIG. 17 is a structural block diagram of an electronic device 1700 according to an exemplary embodiment of this application. The electronic device 1700 may be a portable mobile terminal, such as a smartphone, an in-vehicle terminal, a tablet computer, a moving picture experts group audio layer III (MP3) player, a moving picture experts group audio layer IV (MP4) player, a notebook computer, or a desktop computer. The electronic device 1700 may alternatively be referred to as another name such as a user equipment, a portable terminal, a laptop terminal, or a desktop terminal.

Generally, the electronic device 1700 includes a processor 1701 and a memory 1702.

The processor 1701 may include one or more processing cores, for example, a 4-core processor or an 8-core processor. The processor 1701 may be implemented by using at least one hardware form of digital signal processing (DSP), a field-programmable gate array (FPGA), and a programmable logic array (PLA).

The memory 1702 may include one or more computer-readable storage media. The computer-readable storage media may be non-transitory.

In some embodiments, the electronic device 1700 further includes one or more sensors. The one or more sensors include, but are not limited to, a proximity sensor, a gyroscope sensor, and a pressure sensor.

In some embodiments, the electronic device 1700 further includes another component. A person skilled in the art may understand that the structure shown in FIG. 17 does not constitute a limitation on the electronic device 1700. The electronic device may include more or fewer components than those shown in the figure, or some merged components, or different component arrangements.

An embodiment of this application further provides a computer device. The computer device may be implemented as the terminal or the server shown in FIG. 1. The computer device includes a processor and a memory. The memory has at least one instruction, at least one program, a code set, or an instruction set stored therein. The at least one instruction, the at least one program, the code set, or the instruction set is loaded and executed by the processor to implement the cloud game selection method provided in the foregoing method embodiments.

An embodiment of this application further provides a computer-readable storage medium. The computer-readable storage medium has at least one instruction, at least one program, a code set, or an instruction set stored therein. The at least one instruction, the at least one program, the code set, or the instruction set is loaded and executed by a processor to implement the cloud game selection method provided in the foregoing method embodiments.

An embodiment of this application further provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions, so that the computer device performs the cloud game selection method according to any one of the foregoing method embodiments.

In some embodiments, the computer-readable storage medium may include: a read only memory (ROM), a random access memory (RAM), a solid state drive (SSD), an optical disc, or the like.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A cloud game selection method performed by a computer device, the method comprising:
displaying a plurality of cloud games mounted on a cloud game platform, the cloud games being associated with a first account of a user of the computer device;
receiving a first selection operation on a first cloud game among the plurality of cloud games by the user of the computer device;
in response to the first selection operation:
adding the first account to a first service queue corresponding to the first cloud game, and the first service queue representing an account queuing status of the first cloud game; and
displaying an object arrangement state including the first cloud game selected by the first account, and the object arrangement state being configured for presenting a queuing status of the first account.

2. The method according to claim 1, wherein the displaying the object arrangement state comprises:
displaying the first cloud game and an account queuing order respectively corresponding to the first cloud game as the object arrangement state,
the account queuing order representing a queuing status of the first account in a service queue corresponding to the first cloud game.

3. The method according to claim 1, wherein the displaying the object arrangement state comprises:
displaying a service preview animation based on a queuing status of the first account in at least one service queue, and the service preview animation being a game picture corresponding to a cloud game.

4. The method according to claim 3, wherein the displaying a service preview animation based on a queuing status of the first account in at least one service queue comprises:
displaying a service preview animation corresponding to the first cloud game when a first queuing order of the first account in the first service queue precedes a queuing order of the first account in another service queue.

5. The method according to claim 1, wherein the displaying the object arrangement state comprises:
displaying a first object identifier corresponding to the first cloud game in an object arrangement window, the first object identifier representing that the first account is added to the first service queue corresponding to the first cloud game.

6. The method according to claim 5, wherein after the displaying the first object identifier corresponding to the first cloud game in the object arrangement window, the method further comprises:
displaying an object presentation control in the object arrangement window when a display duration of the first object identifier in the object arrangement window reaches a preset duration; and
displaying the object arrangement state in an expanded manner in response to the object presentation control receiving a trigger operation.

7. The method according to claim 1, wherein the receiving the first selection operation on the first cloud game among the plurality of cloud games by the user of the computer device comprises:
displaying an object arrangement window including the object arrangement state; and
receiving an operation of dragging the first cloud game to the object arrangement window by the user of the computer device as the first selection operation.

8. The method according to claim 1, wherein the receiving the first selection operation on the first cloud game among the plurality of cloud games by the user of the computer device comprises:
receiving a second selection operation on the first cloud game among the plurality of cloud games by the user of the computer device;
in response to the second selection operation:
displaying a first object presentation window corresponding to the first cloud game, the first object presentation window comprising a first queuing control, and the first queuing control being configured for adding the first account to a first service queue corresponding to the first cloud game; and
receiving a trigger operation on the first queuing control in the first object presentation window as the first selection operation.

9. The method according to claim 1, wherein after the displaying the object arrangement state, the method further comprises:
displaying a first prompt window when a second queuing order of the first account in a second service queue corresponding to a second cloud game satisfies a preset queuing condition, the first prompt window prompting the first account to accept a game service provided by the second cloud game.

10. The method according to claim 1, wherein after the displaying the object arrangement state, the method further comprises:
receiving a deletion operation on a fourth cloud game in the object arrangement state, the deletion operation being configured for canceling queuing of the first account in a fourth service queue corresponding to the fourth cloud game; and
removing the fourth cloud game and an account queuing order corresponding to the fourth cloud game in the object arrangement state in response to the deletion operation.

11. A computer device, comprising a processor and a memory, the memory having at least one program stored therein, and the at least one program being loaded and executed by the processor and causing the computer device to implement a cloud game selection method including:
displaying a plurality of cloud games mounted on a cloud game platform, the cloud games being associated with a first account of a user of the computer device;
receiving a first selection operation on a first cloud game among the plurality of cloud games by the user of the computer device;
in response to the first selection operation:
adding the first account to a first service queue corresponding to the first cloud game, and the first service queue representing an account queuing status of the first cloud game; and
displaying an object arrangement state including the first cloud game selected by the first account, and the object arrangement state being configured for presenting a queuing status of the first account.

12. The computer device according to claim 11, wherein the displaying the object arrangement state comprises:
displaying the first cloud game and an account queuing order respectively corresponding to the first cloud game as the object arrangement state,
the account queuing order representing a queuing status of the first account in a service queue corresponding to the first cloud game.

13. The computer device according to claim 11, wherein the displaying the object arrangement state comprises:
displaying a service preview animation based on a queuing status of the first account in at least one service queue, and the service preview animation being a game picture corresponding to a cloud game.

14. The computer device according to claim 11, wherein the displaying the object arrangement state comprises:
displaying a first object identifier corresponding to the first cloud game in an object arrangement window, the first object identifier representing that the first account is added to the first service queue corresponding to the first cloud game.

15. The computer device according to claim 14, wherein after the displaying the first object identifier corresponding to the first cloud game in the object arrangement window, the method further comprises:
displaying an object presentation control in the object arrangement window when a display duration of the first object identifier in the object arrangement window reaches a preset duration; and
displaying the object arrangement state in an expanded manner in response to the object presentation control receiving a trigger operation.

16. The computer device according to claim 11, wherein the receiving the first selection operation on the first cloud game among the plurality of cloud games by the user of the computer device comprises:
displaying an object arrangement window including the object arrangement state; and
receiving an operation of dragging the first cloud game to the object arrangement window by the user of the computer device as the first selection operation.

17. The computer device according to claim 11, wherein the receiving the first selection operation on the first cloud game among the plurality of cloud games by the user of the computer device comprises:
receiving a second selection operation on the first cloud game among the plurality of cloud games by the user of the computer device;
in response to the second selection operation:
displaying a first object presentation window corresponding to the first cloud game, the first object presentation window comprising a first queuing control, and the first queuing control being configured for adding the first account to a first service queue corresponding to the first cloud game; and
receiving a trigger operation on the first queuing control in the first object presentation window as the first selection operation.

18. The computer device according to claim 11, wherein after the displaying the object arrangement state, the method further comprises:
displaying a first prompt window when a second queuing order of the first account in a second service queue corresponding to a second cloud game satisfies a preset queuing condition, the first prompt window prompting the first account to accept a game service provided by the second cloud game.

19. The computer device according to claim 11, wherein after the displaying the object arrangement state, the method further comprises:
receiving a deletion operation on a fourth cloud game in the object arrangement state, the deletion operation being configured for canceling queuing of the first account in a fourth service queue corresponding to the fourth cloud game; and
removing the fourth cloud game and an account queuing order corresponding to the fourth cloud game in the object arrangement state in response to the deletion operation.

20. A non-transitory computer-readable storage medium, having at least one program stored therein, the at least one program being loaded and executed by a processor of a computer device and causing the computer device to implement a cloud game selection method including:
displaying a plurality of cloud games mounted on a cloud game platform, the cloud games being associated with a first account of a user of the computer device;
receiving a first selection operation on a first cloud game among the plurality of cloud games by the user of the computer device;
in response to the first selection operation:
adding the first account to a first service queue corresponding to the first cloud game, and the first service queue representing an account queuing status of the first cloud game; and
displaying an object arrangement state including the first cloud game selected by the first account, and the object arrangement state being configured for presenting a queuing status of the first account.
